(19) United States
(12) Patent Application Publication
(10) Pub. No.: US 2012/0052398 A1
(43) Pub. Date: Mar. 1, 2012

(54) Electrochemical Energy Storage Devices Having a Metallic Interfacial Conducting Agent at the Electrode-Electrolyte Interface

(75) Inventors: John P. Lemmon, Kennewick, WA (US); Xiaochuan Lu, Richland, WA (US); Guanguang Xia, Pasco, WA (US); Zhenguo Yang, Richland, WA (US)

(73) Assignee: BATTELLE MEMORIAL INSTITUTE, Richland, WA (US)

(21) Appl. No.: 12/861,995

(22) Filed: Aug. 24, 2010

(51) Int. Cl. H01M 4/40; H01M 10/058; H01M 4/04; H01M 4/46; H01M 10/0561

(52) U.S. Cl. 429/320; 429/231.9; 429/231.95; 429/321; 429/322; 429/231.6; 429/209; 29/623.5

(57) ABSTRACT

Electrochemical energy storage devices having a metal anode and a solid-state, metal-ion exchange membrane and are characterized by an interfacial layer between the anode and the membrane, wherein the interfacial layer is a solid solution comprising the metal anode and a metallic interfacial conducting agent.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

The current trend of carbon monetization brings out the urgent need of effective, clean electrical storage. Electrochemical energy storage (EES) is considered by many to be a key enabler for the future smart electrical grid, which can be a decentralized, custom interactive system that integrates significant levels of renewable and hybrid plug-in vehicles. However, current EES technologies do not appear capable and are economically unviable for most applications. The ability to store high energy and to simultaneously respond to power management needs that require immediate responses to changes in electrical grids are important aspects that can enable mass penetration by EES devices. Effective devices require improvements to the overall internal resistance of EES devices, which can include sodium beta batteries, in order to improve power related properties and overall cycle life.

### SUMMARY

Embodiments of the present invention can decrease the internal resistance of an EES device by using a metallic interfacial conducting agent to affect the chemical properties at the electrode-electrolyte interface to improve the performance and cycle life. For example, in a particular instance described elsewhere herein, the interfacial conducting agent is, in effect, a wetting agent that improves the electrolyte wetting at the electrode-electrolyte interface. Generally, a decrease in the internal resistance is inversely related to the amount of power (i.e., how quickly) the EES device can charge and discharge. It can also improve the performance and the cycle life. Therefore, embodiments of the present invention can enable EES devices to become more competitive in the energy storage market and, particularly, in the stationary energy storage market.

The electrochemical energy storage devices of the present invention comprise a metal anode and a solid-state, metal-ion exchange membrane and are characterized by an interfacial layer between the anode and the membrane, wherein the interfacial layer is a solid solution comprising the metal anode and a metallic interfacial conducting agent.

In some embodiments, the metal anode comprises sodium. In such instances, the metal-ion exchange membrane can preferably comprise a beta-alumina sodium ion exchange (BASE) membrane and the metal anode can comprise molten sodium. Alternatively, the metal-ion exchange membrane can comprise a sodium super ion conductor (NASICON) membrane and the metal anode can comprise solid sodium. In other embodiments, the metal anode comprises lithium. In such instances, the metal-ion exchange membrane is preferably selected from the group consisting of lithium super ion conductor (LISICON) membranes and lithium phosphorous oxynitride (LIPON). In still another embodiment the metal anode comprises magnesium.

In preferred embodiments, the interfacial conducting agent comprises a transition metal. Exemplary metallic interfacial conducting agents include, but are not limited to copper and tin. Most preferably, the metallic interfacial conducting agent comprises lead.

As used herein with regard to the interfacial conducting agent, a solid solution can refer to a solid-state solution of one or more solutes incorporated in a solid solvent or matrix. The solid solution can be partial or complete and can encompass a mixture or a compound, wherein the mixture exists when the crystal structure of the solid solvent remains unchanged by addition of the solutes. In some embodiments, the interfacial conducting agent comprises an alloy, wherein an alloy refers a particular instance of solid solutions in which the atoms or molecules of one replaces or occupies interstitial positions between the atoms or molecules of the other that can lead to new compositions and may exhibit different crystal lattice properties from the original solid solvent. In some embodiments, the interfacial conducting agent is porous in structure.

The EES devices of the present invention, which comprise a metal anode and a solid-state metal-ion exchange membrane, can be made by forming an interfacial layer between the anode and the membrane, wherein the interfacial layer is a solid solution comprising the metal anode and a metallic interfacial conducting agent.

In some embodiments, the metallic interfacial conducting agent can be deposited on the solid-state, metal-ion exchange membrane surface. In other embodiments, an oxide of the metallic interfacial agent can be deposited on the solid-state metal-ion exchange membrane surface and reacted with the metal anode to reduce the oxide.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized; the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is a graph of conductivity as a function of temperature for a BASE membrane with and without an interfacial conducting agent.

FIGS. 2a and 2b are graphs of electrode/electrolyte interfacial resistance with no interfacial conducting agent.

FIGS. 3a and 3b are graphs of electrode/electrolyte interfacial resistance with an interfacial conducting agent comprising Pb.

FIG. 4 is a graph of electrode/electrolyte interfacial resistance with interfacial conducting agents of Sn and Cu, compared with Pb.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

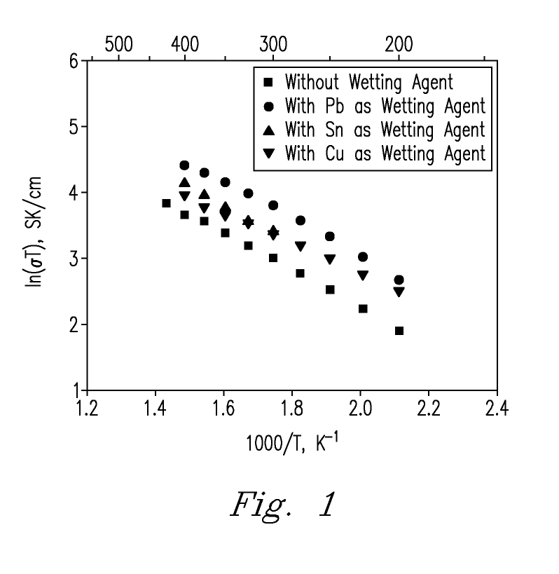

FIGS. 1-4 show a variety of embodiments and/or aspects of the present invention. Referring first to FIG. 1, a graph of conductivity as a function of temperature is shown for a BASE membrane with and without interfacial conducting agents. The graph indicates that the conductivity is much higher with the interfacial conducting agents compared to that without the agents. Pb interfacial conducting agent increases conductivity by almost two times. The conductivity gains with Sn and Cu conducting agents are only slightly lower.

The Pb interfacial conducting agent was applied by coating BASE with a thin layer of saturated lead acetate aqueous solution. The lead acetate was then decomposed to metallic lead in a subsequent heat treatment at 380° C. under an inert atmosphere. The Sn and Cu conducting agents were applied by sputter-coating BASE with a thin layer of nano-sized Sn and Cu particles.

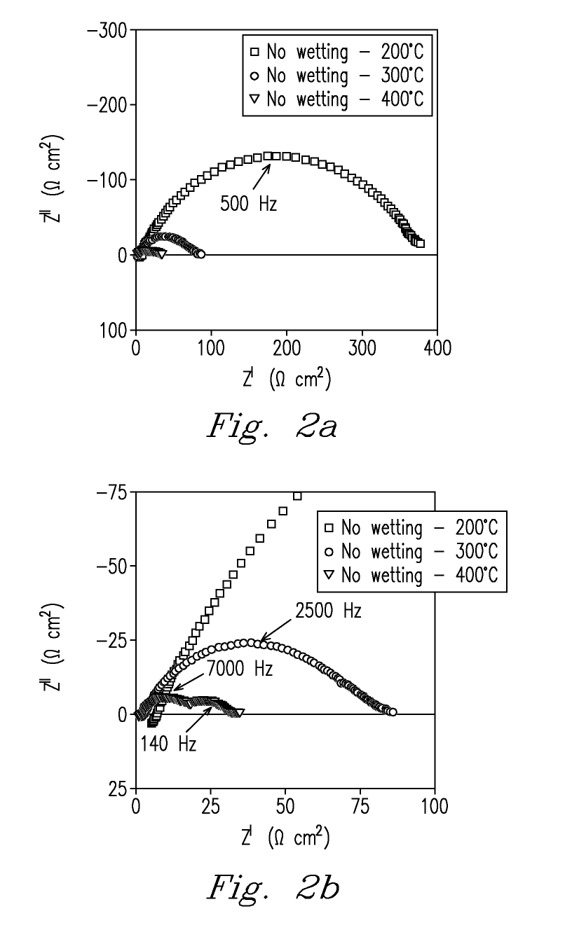

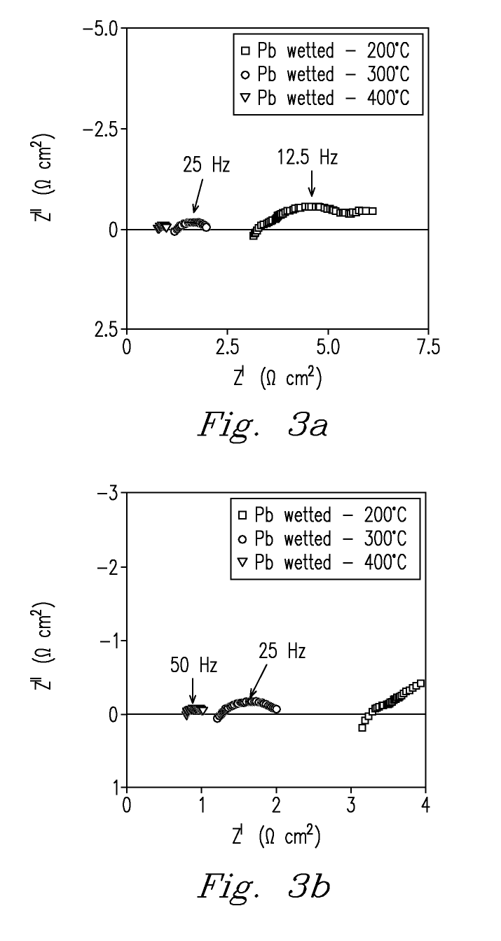

These materials were also measured to determine the electrode/electrolyte interfacial resistance. Referring to FIGS. 3a and 3b, compared to FIGS. 2a and 2b, the Pb interfacial conducting agent significantly reduced the interfacial resistance by approximately 40 times. The interfacial resistance was measured by AC impedance using a sodium-sodium cell configuration (both electrodes were sodium). The cell was heated to 425° C., the temperature was then decreased step by step and impedance data were collected with an interval of 25° C. The frequency range was from 1 MHz to 0.1 Hz and the ac amplitude was 10 mV. The interfacial resistance was calculated from the depressed semicircle in the impedance spectrum.

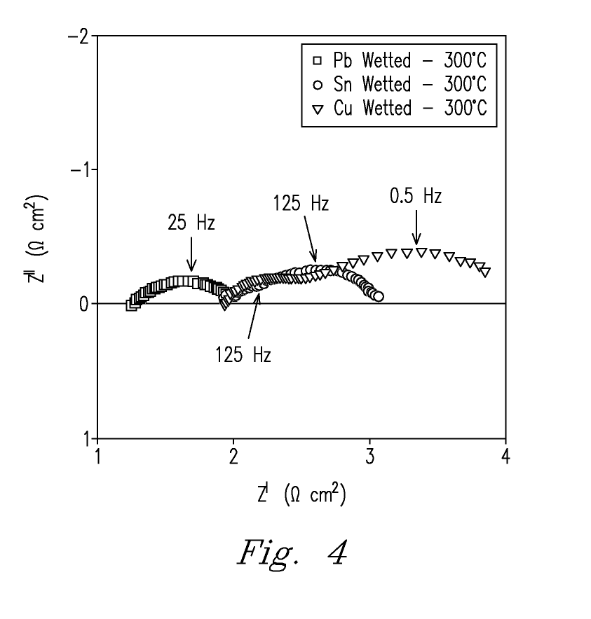

The interfacial resistances with the conducting agents of Sn and Cu were also measured and compared with Pb in FIG. 4. It can be seen that the interfacial resistance with the agents of Sn and Cu was to that achieved with Pb. In particular, the interfacial resistance with Sn was slightly higher than that with Pb while nearly half of that with Cu.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

1. An electrochemical energy storage device comprising a metal anode and a solid-state, metal-ion exchange membrane, the energy storage device characterized by an interfacial layer between the anode and the membrane, wherein the interfacial layer is a solid solution comprising the metal anode and a metallic interfacial conducting agent.

2. The energy storage device of claim 1, wherein the metal anode comprises Na.

3. The energy storage device of claim 2, wherein the metal-ion exchange membrane comprises a beta-alumina sodium ion exchange (BASE) membrane.

4. The energy storage device of claim 2, wherein the metal-ion exchange membrane comprises a sodium super ion conductor (NASICON) membrane.

5. The energy storage device of claim 1, wherein the metal anode comprises Li.

6. The energy storage device of claim 5, wherein the metal-ion exchange membrane is selected from the group consisting of lithium super ion conductor (LISICON) membranes and lithium phosphorous oxynitride (LIPON).

7. The energy storage device of claim 1, wherein the metal anode comprises Mg.

8. The energy storage device of claim 1, wherein the metallic interfacial conducting agent comprises a transition metal.

9. The energy storage device of claim 1, wherein the metallic interfacial conducting agent comprises Pb.

10. The energy storage device of claim 1, wherein the solid solution is an alloy

11. The energy storage device of claim 1, wherein the interfacial conducting layer is a wetting agent.

12. The energy storage device of claim 1, wherein the interfacial conducting layer is porous.

13. A method for making an electrochemical energy storage device comprising a metal anode and a solid-state metal-ion exchange membrane, the method characterized by forming an interfacial layer between the anode and the membrane, the interfacial layer being a solid solution comprising the metal anode and a metallic interfacial conducting agent.

14. The method of claim 13, further comprising depositing the metallic interfacial conducting agent on the solid-state, metal-ion exchange membrane surface.

15. The method of claim 13, further comprising depositing an oxide of the metallic interfacial conducting agent on the solid-state, metal-ion exchange membrane surface and reacting the metal anode with the oxide to reduce the oxide.

16. The method of claim 13, wherein the metal anode comprises Na.

17. The method of claim 13, wherein the solid-state, metal-ion exchange membrane comprises BASE.

18. The method of claim 13, wherein the metallic interfacial conducting agent comprises Pb.

19. The energy storage device of Claim 1, wherein the metallic interfacial conducting agent comprises Sn.

20. An electrochemical energy storage device comprising a Na metal anode and a solid-state, beta-alumina sodium ion exchange (BASE) membrane, the energy storage device characterized by an interfacial layer between the anode and the membrane, wherein the interfacial layer is a solid solution comprising the metal anode and Sn as a metallic interfacial conducting agent.
